(19) United States
(12) Patent Application Publication
(10) Pub. No.: US 2018/0356040 A1
(43) Pub. Date: Dec. 13, 2018

(54) HYDROGEN STORAGE TANK PRODUCED FROM A THERMALLY INSULATING MATERIAL FORMING CYLINDRICAL CASINGS CONTAINING HYDRIDES

(71) Applicant: COMMISSARIAT A L'ENERGIE ATOMIQUE ET AUX ENERGIES ALTERNATIVES, Paris (FR)

(72) Inventors: Olivier GILLIA, Sassenage (FR); Albin CHAISE, Grenoble (FR); Marine PONTHIEU, Fontaine (FR)

(73) Assignee: COMMISSARIAT A L'ENERGIE ATOMIQUE ET AUX ENERGIES ALTERNATIVES, Paris (FR)

(21) Appl. No.: 15/780,889

(22) PCT Filed: Dec. 2, 2016
(86) PCT No.: PCT/EP2016/079651

§ 371 Date: Jun. 1, 2018

(30) Foreign Application Priority Data
Dec. 4, 2015 (FR) 15 61883

(51) Int. Cl. F17C 11/00; F17C 13/00

(52) U.S. Cl. CPC F17C 11/005; C01B 3/0084; F17C 13/001

(57) ABSTRACT

A tank configured to reversibly store hydrogen, including: a plurality of cylindrically shaped casings each containing hydrides and each configured to be filled or emptied by the hydrogen being respectively absorbed or desorbed by the hydrides; a solid part made from thermally insulating material and having a low heat capacity being penetrated, within, by a plurality of cylindrically-shaped slots, the diameter of each of which is greater than that of a casing; a tank in which the casing is housed individually in a slot leaving an annular volume free between same such that to be traversed by a heat transfer fluid, following a defined circuit in each annular volume from an inlet common to all the annular volumes to an outlet which is also common.

### TECHNICAL FIELD

The present invention relates to a tank for reversible storage of hydrogen H₂ comprising a plurality of cylindrical casings containing hydrides.

The present invention aims to produce a thermostatically controlled bath of heat-transfer fluid within the tank, simply, efficiently, inexpensively, and minimizing the volume of fluid to be heated or to be cooled.

There are numerous possible applications of the invention and they may relate to the entire field of applications of hydrogen storage.

They may be dedicated hydrogen storage tanks for means of transport, such as boats, submarines, cars, buses, trucks, construction site equipment, two-wheeled vehicles, as well as those for the field of transportable power supply systems, such as batteries for portable electronic equipment (portable telephones, portable computers, etc.).

They may also be tanks for hydrogen storage in larger quantity, and stationary, such as power generating units, storage of H₂ produced by intermittent energy sources (wind power, photovoltaic panels, geothermal energy, etc.).

In general, the tank according to the invention may be used for purposes solely for transporting hydrogen, but also for on-board storage of hydrogen for fuel cells or a heat engine or else stationary storage of hydrogen.

### PRIOR ART

Energy sources alternative to petroleum are being sought notably on account of the decline in petroleum reserves. One promising carrier for these energy sources is hydrogen, which can be used in fuel cells to produce electricity.

Hydrogen is an element that is of very wide occurrence in the universe and on Earth, and can be produced starting from coal, natural gas or other hydrocarbons, but also by simple electrolysis of water using for example electricity produced by solar power or wind power.

Fuel cells operating on hydrogen are already used in certain applications, for example in motor vehicles, but are still not widely used, notably owing to precautions that have to be taken and difficulties in hydrogen storage.

In order to reduce the storage volume, hydrogen may be stored in the form of gaseous hydrogen compressed at between 350 and 700 bar, but this energy densification may be further improved by incorporating hydrides in the pressure vessel.

For even higher density, hydrogen may also be stored in liquid form, but this type of storage only gives low storage efficiency and does not allow long-term storage. The transition of a volume of hydrogen from the liquid state to the gaseous state in normal conditions of pressure and temperature results in an increase in its volume by a factor of about 800. Tanks for hydrogen in liquid form do not generally have very high impact strength, so there are important safety problems.

Hydrogen may also be stored in solid form by means of hydrides. This form of storage gives a high volume density of storage while minimizing the energy effect of the storage on the overall efficiency of the hydrogen chain, i.e. from its production to its conversion to another form of energy.

The principle of storage of hydrogen in solid form as hydrides is as follows: certain materials and in particular certain metals possess the capacity to absorb hydrogen to form a hydride, said reaction being called absorption. The hydrides formed may again give gaseous hydrogen and a metal. This reaction is called desorption. Absorption or desorption occur depending on the hydrogen partial pressure and the temperature.

For example, a metal powder is used, which is brought into contact with hydrogen, a phenomenon of absorption occurs and a metal hydride is formed. The hydrogen is released by a mechanism of desorption.

It is also possible to use complex hydrides such as tetrahydroborates M(BH₄), tetrahydroaluminates or alanates M(AlH₄) for hydrogen storage and release.

Regardless of the form of the hydrides selected, storage of hydrogen is an exothermic reaction, i.e. which releases heat, whereas release of hydrogen is an endothermic reaction, i.e. which absorbs heat.

The aim is notably to have rapid loading of the metal powder with hydrogen. To obtain this rapid loading, it is necessary to remove the heat produced during said loading to avoid hampering the absorption of hydrogen on the powder or the metallic matrix. During hydrogen release, heat is supplied. Consequently, the efficiency of cooling and heating determines the rates of loading and release.

In other words, it is necessary to remove heat during absorption and supply heat during desorption in order to facilitate the reactions and increase the effectiveness of the hydride in terms of the flow rate of hydrogen entering or leaving the storage tank. Thus, a tank for hydrogen in the form of hydrides generally comprises a vessel containing the hydrides and incorporates a heat exchanger within it.

Some known hydrogen tanks have been designed to house a plurality of casings each containing hydrides within an external vessel, inside which a heat transfer fluid is circulated in order to immerse the casings in a bath with optimum thermostatic control, i.e. at a temperature that is controlled as accurately as possible, the bath being at a relatively hot temperature for hydrogen release and at a relatively cold temperature for hydrogen loading.

We may mention patent application JP05302699A, which discloses a tank for reversible storage of hydrogen comprising a plurality of cylindrical casings containing metal powder, housed in an external vessel and arranged parallel to one another, the casings being maintained by the hydrogen collector/discharger, a component for fluidic distribution moreover being arranged inside the vessel to provide uniform distribution of the heat transfer fluid between the casings.

Patent application JP61244997A also discloses a tank of this type with a plurality of casings containing hydrides and housed in an external vessel, the casings being of equilateral triangular shape, held in place by a support in the form of combs passing through the vessel, and arranged in uniform arrays so that two adjacent casings are oriented head to tail.

The “Helmholtz-Zentrum Geesthacht” laboratory has proposed a prototype of a tank for reversible storage of hydrogen comprising a plurality of cylindrical casings containing sodium alanates immersed in a thermostatically controlled oil bath both for absorption and desorption of the hydrogen: see publication [1].

The company LABTECH INT, Ltd has also proposed a similar prototype tank with cylinders containing lanthanum-nickel LaNi5: see reference [2].

The known tanks, inside which there is a thermostatically controlled bath of heat transfer fluid, have certain important drawbacks.

Firstly, the heat exchanges between casings containing the hydrides and the heat transfer fluid are not necessarily optimized.

Next, the sensible heat that is required for cooling or heating the heat transfer fluid to keep the bath thermostatically controlled during hydrogen discharge or loading, respectively, is considerable owing to the large volume of heat transfer fluid to be circulated.

Finally, a large number of components is required for making these tanks, notably as it is necessary to have an external vessel as such for delimiting the bath and for providing the thermal insulation with respect to the exterior, to have separate mechanical support for holding the casings in place and if applicable a component for fluidic distribution within the vessel for distributing the heat transfer fluid to be circulated between casings. Production of the known tanks with a thermostatically controlled bath may thus be complicated.

There is therefore a need for further improvement of tanks for reversible storage of hydrogen, of the type comprising a plurality of casings containing hydrides to be immersed in a thermostatically controlled bath of heat transfer fluid, notably in order to improve the heat exchanges between the heat transfer fluid and the hydrogen, to facilitate production of the tank and of the thermostatically controlled bath, and to lower the cost thereof.

The aim of the invention is to meet this need at least partially.

### DESCRIPTION OF THE INVENTION

For this purpose, the invention relates to a tank, intended for reversible storage of hydrogen, comprising:
several casings of cylindrical shape each containing hydrides and each suitable for filling or emptying with hydrogen H₂ to be absorbed or desorbed by the hydrides, respectively,
a solid component made of thermally insulating material and having a low heat capacity, within which there are several housings of cylindrical shape, each with a diameter greater than that of a casing,

and in said tank each casing is housed individually in a housing, leaving an annular space free between them so that the latter may be traversed by a heat-transfer fluid, following a circuit in each defined annular space from an inlet common to all the annular spaces, to an outlet, which is also common.

Thus, the invention consists of creating a tank in which cylindrical casings containing hydrides are immersed in a bath of heat-transfer fluid, which is, however, of a very small volume as it is defined by the spaces between each casing and its housing within the solid component, the diameter of which is slightly or even very slightly greater. Owing to this, a film of water of small or even of very small thickness may be circulated around each casing.

Compared to the tanks for reversible storage of hydrogen with a thermostatically controlled bath according to the prior art, and since the housings for the cylindrical casings are made in a solid component made of thermally insulating material and have a low heat capacity, there is a considerable decrease in sensible heat required for cooling or heating the water for thermostatic control during the process of hydrogen discharge or loading, minimizing the amount of water employed.

It goes without saying that the material of the solid component must be impermeable or must be made impermeable on the surfaces in contact with the liquid so that no water is absorbed.

Thus, compared to the tanks with a thermostatically controlled bath according to the prior art, the invention makes it possible to obtain the following improvements:
the space between the cylindrical casings is occupied by a material with low heat capacity, which makes it possible to improve the dynamics of the tank by reducing the thermal inertia of the heat-transfer fluid,
supply/removal of heat by the heat-transfer fluid takes place closest to each casing in which the exothermic/endothermic reaction occurs during loading/discharge of the hydrogen. The efficiency of the heat exchanges in a tank according to the invention is therefore improved relative to a tank with a thermostatically controlled bath according to the prior art in which supply/removal of heat takes place in a large volume that comprises the space between the casings,
the use of an insulating material for making the structure that supports the cylindrical casings makes it possible for the functions of holding the cylinders in place, circulation of the heat-transfer fluid and thermal insulation to be combined together in a single solid component.

The heat-transfer fluid passing through the tank according to the invention may advantageously be an oil, a molten salt, or glycol solution.

Advantageously, each cylindrical housing is arranged concentrically around a cylindrical casing.

According to an advantageous embodiment, the casings and the housings are of right circular cylindrical shape.

According to a first variant embodiment, the solid component is in one piece, preferably obtained by molding.

According to another variant embodiment, the solid component is an assembly of blocks stacked on top of one another and held in position, each block being perforated by a portion of the cylindrical channels.

According to another variant embodiment, the solid component that is made in one piece or consists of blocks stacked on top of one another may further comprise recesses separate from the housings, in order to reduce the amount of material between each cylindrical housing.

Preferably, the material of the solid component has a volumetric heat capacity less than or equal to half the volumetric heat capacity of the heat-transfer fluid.

Also preferably, the material of the solid component may be a polymer, selected for example from expanded polypropylene (EPP), expanded polystyrene (EPS), expanded polyurethane, acrylic foam, ethylene vinyl acetate (EVA), polyethylene foam, neoprene foam. One advantage of having a solid component made of EPP is that the tank according to the invention is reinforced mechanically and can therefore withstand shocks, in case of earthquake for example.

The cylindrical casings may be blind.

The width of the annular space may be between 1% and 50% of the diameter of the cylindrical casing.

According to an advantageous embodiment, the solid component comprises at least one end portion forming a heat-transfer fluid collector or distributor, comprising blind portions of the housings in which the ends of the casings are housed, the end portion further comprising at least one main channel and secondary channels respectively for recovery or supply of the heat transfer fluid from the exterior, the secondary channels being connected to the main channel and to the blind portions of the housings in order to distribute the heat-transfer fluid in the annular spaces (V).

Thus, a collector and/or a distributor of heat-transfer fluid may be integrated directly in the solid component. It goes without saying that distribution or collection of the heat-transfer fluid may be performed with other means, notably in order to facilitate cleaning of the heat-transfer fluid circuit.

The heat capacity of the solid component is advantageously less than that of the heat transfer fluid passing through the tank divided by a factor of 10. Preferably, the heat capacity Cp of the solid component is below 400 J/kg/K, more preferably below 40 J/kg/K.

Similarly, the thermal conductivity of the solid component is advantageously less than that of the heat transfer fluid passing through the tank divided by a factor of 10. Preferably, the thermal conductivity of the solid component is below 2 W/m/K.

The material of which the solid component consists is advantageously selected from polymers, for example a polyamide, polypropylene, polyurethane, polystyrene, with forming thereof in the form of expanded foam.

According to an advantageous embodiment, the tank may comprise components forming flow distributors, each arranged in a secondary channel so as to have approximately equal flow rates in the annular spaces.

According to an advantageous embodiment, the blind ends of the casings abut against the blind portions of housings of an end portion of the solid component. Depending on the application and the calculated mechanical strength of the tank, if the solid component is not strong enough to support the cylindrical casings, we may also envisage supporting them with structural components made of stronger material, arranged outside the tank.

Advantageously, the housings are made with their axes parallel and are uniformly distributed in the volume of the solid component.

The tank according to the invention may comprise a vessel, suitable for being pressurized, preferably by means of the heat-transfer fluid, within which the casings and the solid component are housed.

The invention also relates to a method of operation of a tank that has just been described, comprising

a/ for absorption of hydrogen:
a step of injecting and circulating a heat-transfer fluid at a relatively cold temperature in the annular spaces so as to create a bath thermostatically controlled to a relatively cold temperature;
a step of injecting hydrogen into the cylindrical casings containing the hydrides, the circulation of the heat-transfer fluid being maintained;

b/ for desorption of hydrogen:
a step of injecting and circulating a heat-transfer fluid at a relatively hot temperature in the annular spaces so as to create a bath thermostatically controlled to a relatively hot temperature;
a step of collecting the hydrogen from the cylindrical casings containing the hydrides, the circulation of the heat-transfer fluid being maintained.

In step a/, injection of hydrogen may take place right from the start of cooling or once the thermostatically controlled cold bath is obtained.

In step b/, collection of the hydrogen may take place before heating the assembly, or once the thermostatically controlled hot bath is obtained.

The heat-transfer fluid is preferably a liquid, preferably water, or water with glycol or some other.

### DETAILED DESCRIPTION

Other advantages and features of the invention will become clearer on reading the detailed description of embodiment examples of the invention given for purposes of illustration, and nonlimiting, referring to the following figures, where:

FIG. 1 is a schematic perspective view of an example of a tank for reversible hydrogen storage according to the invention;

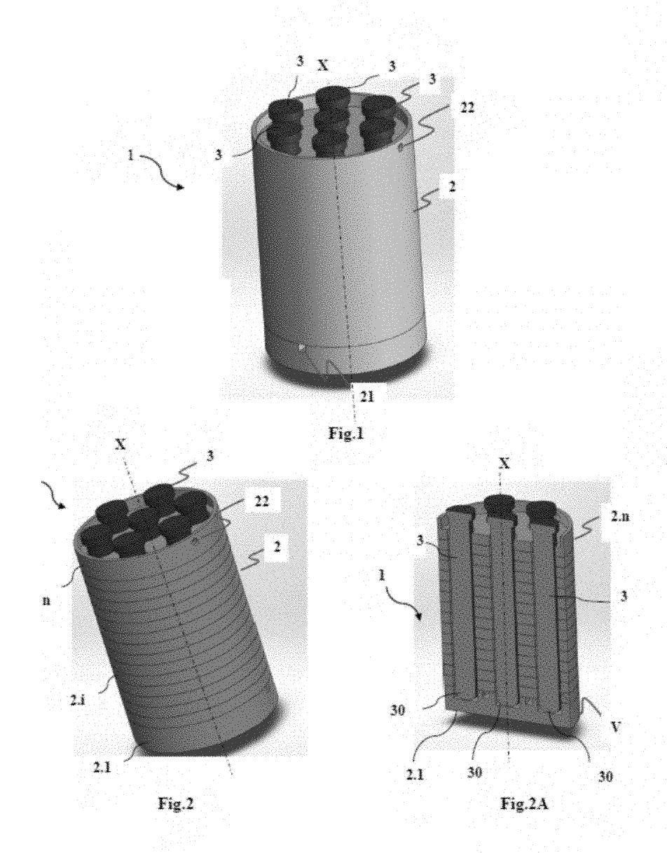

FIG. 2 is a schematic perspective view of another example of a tank for reversible hydrogen storage according to the invention;

FIG. 2A is a view in longitudinal section of the tank according to FIG. 2;

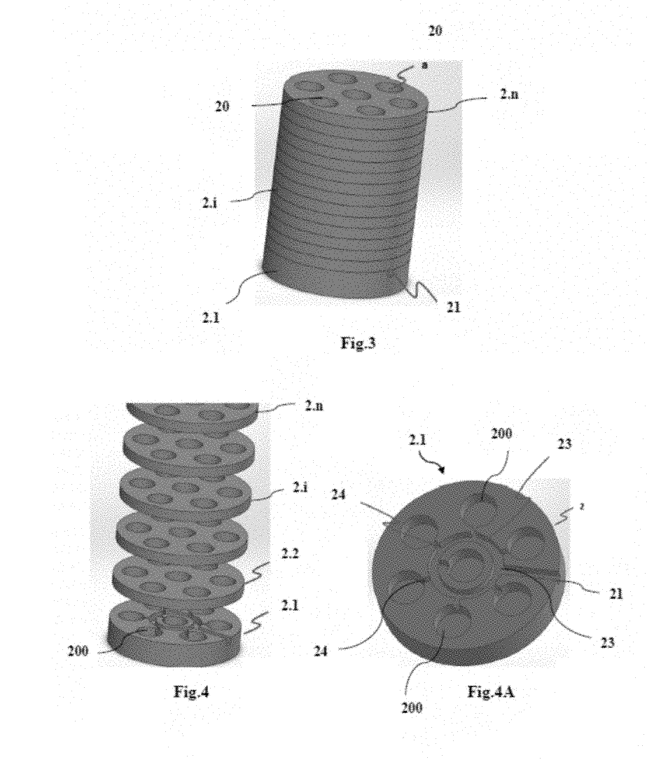

FIG. 3 is a schematic perspective view of the solid component forming the sheath of the casings containing hydrides of the tank according to FIG. 2;

FIG. 4 is an exploded view showing the various blocks making up the solid component shown in FIG. 3;

FIG. 4A is a perspective top view showing an end block of the solid component shown in FIG. 3, which constitutes a distributor or a collector of heat-transfer fluid;

FIG. 5 is a perspective see-through view of a tank according to FIG. 2 additionally equipped with a collecting block and a distributing block at each of its ends;

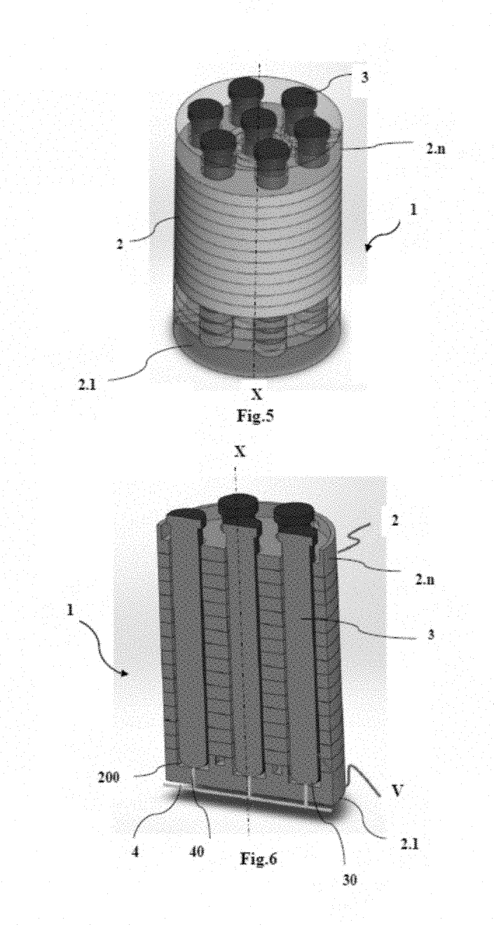

FIG. 6 is a view in longitudinal section of the tank according to FIG. 2 and according to a variant embodiment of the support of the cylindrical casings;

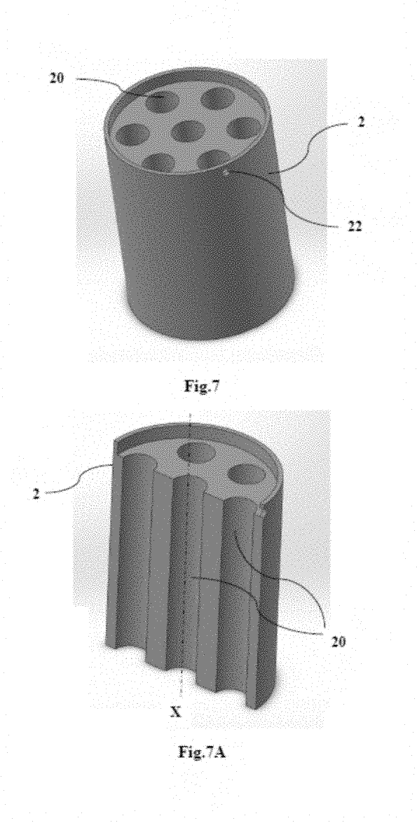

FIGS. 7 and 7A are schematic views respectively in perspective and in longitudinal section of an example of a one-piece solid component used in a tank according to the invention;

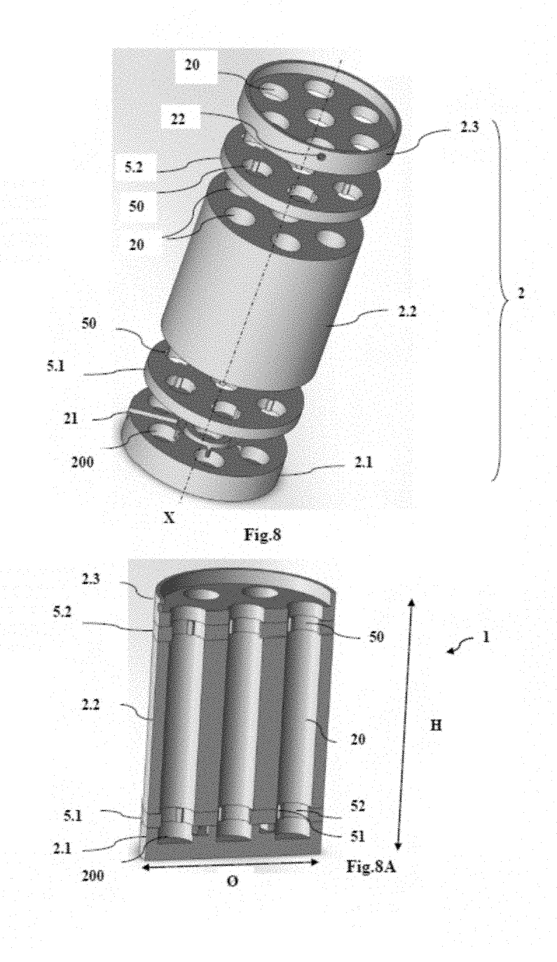

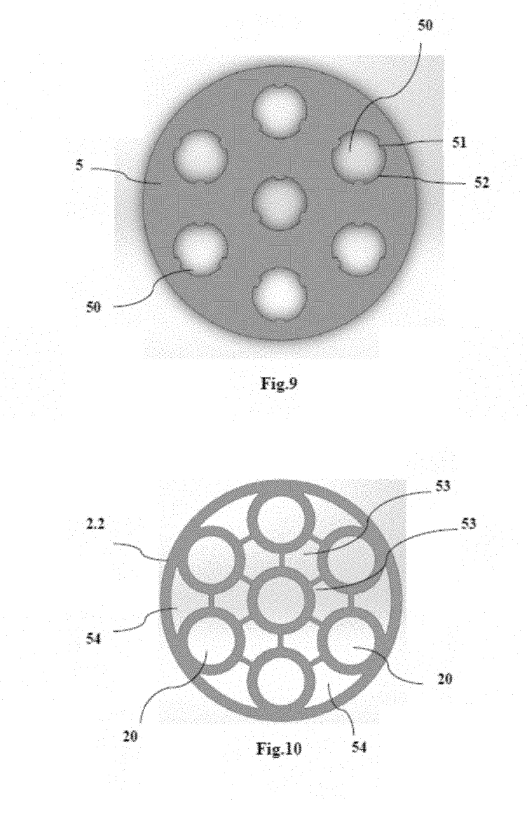

FIGS. 8 and 8A are schematic views respectively in perspective and in longitudinal section of a variant embodiment of a solid component of the tank according to the invention, according to which components for adjusting the casings are inserted in the stack of blocks making up the solid component;

FIG. 9 is a schematic top view of an adjusting component arranged in a tank illustrated in FIGS. 8 and 8A;

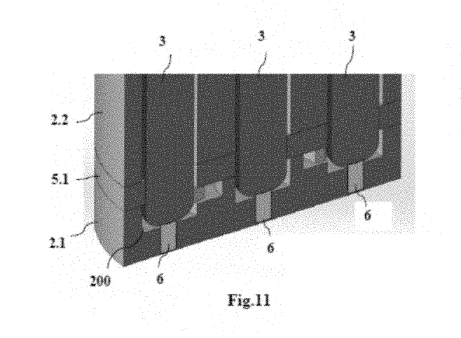

FIG. 10 is a schematic cross-sectional view showing a variant of a one-piece solid component according to the invention;

FIG. 11 is a schematic cross-sectional detail view at the bottom of the tank according to a variant with adjusting components for axial support of the casings of hydrides.

Throughout the present application, the terms “vertical”, “lower”, “upper”, “low”, “high”, “below”, “above”, “height” are to be understood by reference relative to a tank for reversible hydrogen storage according to the invention such as it is in a vertical operating configuration.

FIG. 1 shows a tank 1 for reversible storage of hydrogen H₂ according to the invention.

The tank 1 comprises firstly a solid component 2 made of insulating material with a low heat capacity, in which a plurality of identical casings, of cylindrical shape with a right circular cross section 3, and each containing metal hydrides, is housed and held in place.

More precisely, the solid component 2 comprises a plurality of identical cylindrical housings 20 which have their axes arranged parallel to the longitudinal axis X of the tank 1 and are uniformly distributed in the volume of the solid component 2.

According to the invention, inside each housing 20, a single cylindrical casing 3 is housed and held in place, leaving an annular space V free between them so that the latter may be traversed by a heat-transfer fluid (FIGS. 2A and 6). For example, the width of an annular space may be equal to 5 mm for a diameter of the cylindrical casing of 76 mm.

In the examples illustrated, the tank 1 comprises seven identical cylindrical casings 3 each housed in a housing 20, being parallel to the axis X and being uniformly distributed in the volume of the solid component 2.

The solid component 2 may advantageously be made of EPP. This solid component 2 may be made in one piece, for example by molding (FIGS. 1, 7, 7A) or by assembling a number n of blocks 2.1, . . . 2.i, . . . 2.n stacked on top of one another and held in position (FIGS. 2 to 6). Production of the solid component 2 by assembling several separate blocks is advantageous as it is easy to carry out by cutting blocks and then stacking.

It is then possible to ensure imperviousness to water by gluing and sealing the blocks together (FIGS. 3 and 4), but it is also possible to consider that the hermeticity will not be sufficient, and place the whole in an impervious tank in order to collect any leaks.

Regardless of the manner of production envisaged for the solid component 2 (in one piece, or assembled from blocks that are stacked and held in position), a heat-transfer fluid circuit is provided in each annular space defined from an inlet 21 common to all the annular spaces V, to an outlet 22, which is also common.

In operation, the tank 1 may be arranged vertically, i.e. with the cylindrical casings 3 vertical. Two directions of circulation of the heat-transfer fluid are possible, i.e. from top to bottom or from bottom to top, as illustrated in the figures. During heating, i.e. when desorption of hydrogen is to be carried out, it may be preferable to inject the hot heat-transfer fluid at the top, and during cooling, i.e. when absorption of hydrogen is to be carried out, inject the cold heat-transfer fluid at the bottom to allow natural thermal stratification to occur.

Instead of injecting a hot heat-transfer fluid, it may also be envisaged to heat this fluid directly in each of the annular spaces around the casings 3, for example either with a resistance wound around each casing, or with a resistance located in the part of the tank located below the casings 3.

In the manner of construction in which the solid component 2 is produced by assembly of blocks, an advantageous embodiment is to etch a circuit for distribution/collection of the heat-transfer fluid in an end block 2.1 or 2.n to form an integrated distributor/collector. The block that is etched may for example be the lower block 2.1 (FIGS. 4 and 4A).

In this embodiment, the heat-transfer fluid collector or distributor 2.1 comprises blind portions 200 of the housings 20 intended to receive the blind ends 30 of the casings 3. This collector or distributor 2.1 further comprises a main channel 23 and secondary channels 24 respectively for recovery or supply of the heat transfer fluid from the exterior. The secondary channels 24 are connected to the main channel 23 and to the blind portions 200 of the housings 20 in order to distribute the heat-transfer fluid in the annular spaces V from the inlet 21 (FIGS. 4 and 4A) or to the outlet 22.

The rules of the art of fluid distribution require a flow cross section in channel 23 larger than the flow cross section of each secondary channel 24. In order to have approximately equal flow rates in the annular spaces V, arrangement of a component forming flow distributors in each secondary channel 24 may be envisaged.

Production both of the heat-transfer fluid distributor 2.1 and of the heat-transfer fluid collector 2.n by etching them, in a manner that may or may not be identical, may be envisaged. The see-through drawing in FIG. 5 shows the tank 1 with, at one of its ends, an etched block 2.1 as a distributor and at the other end an etched block 2.n as a collector of the heat-transfer fluid.

Other forms of distribution/collection circuit are possible.

If the dimensioning of the lower block 2.1 is insufficient, notably if it cannot support by itself the weight of the casings 3 with the hydrides and the stored hydrogen, supporting of the casings from outside may be envisaged, for example by means of a support 4 in the form of a comb, each branch 40 of which will support a casing 3.

FIGS. 8 and 8A show a variant embodiment of the solid component, according to which one or more adjusting components 5, 5.1, 5.2 are inserted in the stack of blocks 2.1, . . . 2.i, . . . 2.n.

The function of the adjusting component or components 5, 5.1, 5.2 is to hold the cylinder of the casings 3 in place laterally and therefore allow them to be perfectly centered relative to their respective housing 20, which defines an annular space that is perfectly centered around each casing 3.

More precisely, as illustrated in FIGS. 8 and 8A, the solid component is an assembly of a stack comprising successively, from bottom to top, a heat-transfer fluid collecting or distributing block 2.1, a first adjusting component 5.1, a central block 2.2 defining the major part of the height of the housings 20, a second adjusting component 5.2, and a fluid collecting or distributing block 2.3.

In the type of manufacture in FIG. 6, components 5, 5.1 and 5.2 may also be inserted at different levels between the plates 2.n, i.e. at intermediate heights for holding the cylindrical casings 3 in place axially.

The collecting/distributing blocks 2.1, 2.3 may advantageously be produced as described with reference to FIGS. 2 to 6.

As an illustrative example, the solid component 2 shown in FIGS. 8 and 8A may have a height of the order of 500 mm and a diameter of the order of 300 mm.

As illustrated in FIG. 9, an adjusting component comprises as many through openings 50 as there are housings. Each through opening 50 is delimited by an edge with one or more projections 51 relative to their principal diameter 52.

In the example illustrated, three uniformly distributed projections 51 are provided, which define between them a diameter approximately equal to the outside diameter of a casing 3. Thus, the projections 51 hold in place laterally each casing 3, which is housed in a housing 20 and in an opposite opening 50. The annular space defined between each casing 3 and the principal diameter 52 allows the heat-transfer fluid to circulate.

Although production of the fastening projections 51 is only shown over the height of the adjusting components 4.1, 4.2, it is equally possible to envisage making them over the full height of the solid component when the latter is made in one piece.

FIG. 10 shows a variant of a one-piece solid component 2 that comprises, in addition to the housings 20, recesses of variable size 53, 54 over at least part of the height of the component 2. These recesses 53, 54, which are separate from the housings 20, make it possible to reduce the amount of material between each cylindrical housing 20, and can therefore reduce the weight of component 2.

FIG. 11 shows a variant for axial support and axial adjustment of the casings 3 at the bottom of the tank 1. Wedges 6 inserted in the block of the bottom 2.1 allow individual adjustment of the height of each casing 3 in its housing 20.

For angular adjustment, it is possible to use, together with or instead of the fastening projections 51, a cover made of insulating material that will fit on top of all the casings of hydrides 3, and that comprises holes in which the upper ends of the casings 3 are inserted.

The operation of the tank 1 according to the invention is now described, with water as the heat-transfer fluid.

Each of the cylindrical casings 3 housed in a housing 20 of the solid component 2 with an annular space between them is filled with a hydride material but initially does not contain any hydrogen.

Cold water is injected from the inlet 21 to the outlet 22 at a flow rate calculated by rules of heat exchange between a casing 3 and water. The flow of water is distributed uniformly in each annular space around a casing 3. A thermostatically controlled bath is formed, the level of the bath being controlled by good dimensioning of the aperture of outlet 22, which must be capable of passing the maximum flow rate imposed at the inlet 21.

Then hydrogen is injected in the casings 3, the hydride material absorbs the hydrogen, and heat is thus produced. The temperature rise inside the casings 3 should gradually block the reaction of absorption of hydrogen in the hydride material. To prevent this, the heat is removed by conduction inside the casings 3 and then by exchange with the water in the annular spaces V. Loading of the hydrogen may then continue normally. The kinetics of filling is determined by the capacity for cooling the hydrogen. For a higher hydrogen filling rate, it is possible for example to increase the water flow rate.

Conversely, in order to use the hydrogen from the tank, i.e. desorb the hydrogen from the tank 1, it is necessary to heat the casings 3. Then heated water is injected via the inlet 21, and will circulate around each casing 3 in the annular space V.

The advantage of the tank 1 according to the invention that has just been described, relative to a tank with a thermostatically controlled bath in which the casings containing the hydrides are immersed in a single large water bath, is that a mass of water does not have to be heated needlessly. This mass is replaced by the material with low heat capacity of the solid component 2.

This advantage is all the more important because often, in the systems with tanks according to the prior art, the heat transfer circuit is a closed loop, and the temperature rise of the system includes the energy necessary for raising the temperature of the heat transfer fluid itself. Minimizing this amount of energy owing to the invention is therefore important.

The invention is not limited to the examples that have just been described; notably, features of the examples illustrated may be combined in variants that are not illustrated.

Other variants and improvements may be envisaged while remaining within the scope of the invention.

In the embodiments illustrated where the solid component 2 is produced by stacking blocks, simple holding of the latter in position is necessary. This may relate to all the configurations in which containment of the heat transfer fluid in an external tank is selected.

However, gluing together the blocks stacked on top of one another may also be envisaged. In this embodiment, the stacked blocks are preferably made of polymer and the appropriate type of adhesive is selected in relation to the polymers used for the blocks. For example, epoxy adhesives, adhesives of the polyurethane type and cyanoacrylate adhesives are suitable for gluing the polymer materials.

In the embodiment with a stack of blocks that are not glued for making component 2, which is placed in a container containing a heat transfer fluid, it is immediately possible to dispense with a distribution block as such, and instead reserve a distribution space under a block of the type illustrated in FIGS. 7 and 7A.

In the embodiments shown, the casings of metal hydrides 3 are adjusted axially with wedges 6 inserted at the bottom of the tank 1 and angularly with the fastening projections and/or an insulating cover (not shown) comprising holes in which the casings of metal hydrides 3 will be inserted individually. These methods of adjustment are perfectly suitable for most relatively light casings with hydrides. For heavy casings with hydrides, or with an insulating block at the bottom that has lower mechanical strength, it may be envisaged to support the casings 3 axially by supporting the casings with wedges made of stronger material and radially with a cover, more generally a perforated plate adjusted to the upper end of the cylinders, the material of which has higher mechanical strength, for example a metal or a stronger polymer.

In the embodiments illustrated, the casings 3 of metal hydrides are blind, i.e. with the bottom end blocked, the metal hydrides being filled from the other end. We may also envisage casings with openings at each end, these openings defining respectively a separate inlet and outlet in the tank. A system must then be provided for closure of each side of the casings. A closure system of this kind may for example consist of a domed cover fixed by welding onto each open end of the casings or with a removable system, such as a flange or threaded plug system.

### References Cited

[1]: O., Bellosta Von Colbe, J. M., Lozano, G. A., ( . . . ), Dornheim, M., Klassen, T “Testing of hydrogen storage tank based on 8 kg NaAlH4” 2010 AIChE Annual Meeting, Conference Proceedings;

[2]: http://www.labtech-hydrogen.com/common_files/brochure.pdf; http://www.labtech-hydrogen.com/index.php?page=EVINGEN.

1-17. (canceled)

18. A tank, configured to reversibly store hydrogen, comprising:
plural casings of cylindrical shape each containing hydrides and each configured to fill or empty with hydrogen H₂ to be absorbed or desorbed by the hydrides, respectively;
a solid component made of thermally insulating material with a low heat capacity with its interior perforated by plural housings of cylindrical shape, the diameter of each being greater than that of a casing;
in the tank, each casing is housed individually in a housing, leaving an annular space free between them so that the latter may be traversed by a heat-transfer fluid, along a circuit in each annular space defined from an inlet common to all the annular spaces to an outlet, which is also common.

19. The tank as claimed in claim 18, wherein each cylindrical housing is arranged concentrically around a cylindrical casing.

20. The tank as claimed in claim 18, wherein the casings and the housings are of right circular cylindrical shape.

21. The tank as claimed in claim 18, wherein the solid component is in one piece.

22. The tank as claimed in claim 18, wherein the solid component is an assembly of blocks stacked on top of one another and held in position, each block being perforated by a portion of the cylindrical housings.

23. The tank as claimed in claim 18, wherein the solid component further comprises recesses separate from the housings.

24. The tank as claimed in claim 18, wherein the material of the solid component has a volumetric heat capacity less than or equal to half the volumetric heat capacity of the heat-transfer fluid.

25. The tank as claimed in claim 18, wherein the material of the solid component is a polymer, selected from expanded polypropylene (EPP), expanded polystyrene (EPS), expanded polyurethane, acrylic foam, ethylene vinyl acetate (EVA), polyethylene foam, neoprene foam.

26. The tank as claimed in claim 18, wherein the width of the annular space is between 1% and 50% of the diameter of the cylindrical casing.

27. The tank as claimed in claim 18, wherein the cylindrical casings is blind.

28. The tank as claimed in claim 18, wherein the solid component comprises at least one end portion forming a heat-transfer fluid collector or distributor, comprising blind portions of the housings in which the ends of the casings are housed, the end portion further comprising at least one main channel and secondary channels respectively for recovery or supply of the heat transfer fluid from the exterior, the secondary channels being connected to the main channel and to the blind portions of the housings to distribute the heat-transfer fluid in the annular spaces.

29. The tank as claimed in claim 27, further comprising components forming flow distributors, each arranged in a secondary channel to have approximately equal flow rates in the annular spaces.

30. The tank as claimed in claim 27, wherein the blind ends of the casings abut against blind housing portions of an end portion of the solid component.

31. The tank as claimed in claim 18, wherein the housings are made with their axes parallel and uniformly distributed in the volume of the solid component.

32. The tank as claimed in claim 18, further comprising a vessel, configured to be pressurized, by heat-transfer fluid, within which the casings and the solid component are housed.

33. A method of operation of a tank as claimed in claim 18, comprising:
a) for absorption of hydrogen:
injecting and circulating a heat-transfer fluid at a relatively cold temperature in the annular spaces to create a bath thermostatically controlled to a relatively cold temperature;
injecting hydrogen into the cylindrical casings containing the hydrides, the circulation of the heat-transfer fluid being maintained;
b) for desorption of hydrogen:
injecting and circulating a heat-transfer fluid at a relatively hot temperature in the annular spaces to create a bath thermostatically controlled to a relatively hot temperature;
collecting the hydrogen from the cylindrical casings containing the hydrides, the circulation of the heat-transfer fluid being maintained.

34. The method as claimed in claim 33, wherein the heat-transfer fluid is a liquid.
